(19) United States
(12) Patent Application Publication
(10) Pub. No.: US 2025/0065541 A1
(43) Pub. Date: Feb. 27, 2025

(54) Heating Device for Heating a Roller, Roller, and a Calender or Embossing Cassette

(71) Applicants: Matthews International GmbH, Vreden (DE); Matthews International Corporation, Pittsburgh, PA (US)

(72) Inventor: Rene WOLTERS, Stadtlohn (DE)

(21) Appl. No.: 18/809,697

(22) Filed: Aug. 20, 2024

(30) Foreign Application Priority Data
Aug. 21, 2023 (WO) PCT/EP2023/072912

(51) Int. Cl. B29C 43/52; B29C 43/46; B29C 59/00; B29C 59/04

(52) U.S. Cl. CPC B29C 43/52; B29C 43/46; B29C 59/002; B29C 59/04

(57) ABSTRACT

The invention relates to a heating device for heating a roller, wherein the heating device has a heating element which is configured to be inserted into a bore of the roller and to provide, preferably to provide electrically, heating power and/or heat for heating the roller and/or a roller body of the roller, and wherein the heating device has a clamping set which is arranged on a surface of the heating element and which is configured to contact an inner surface of the bore when the heating device is inserted into the bore of the roller and to transfer heat from the heating element conductively to the roller and/or the roller body. The invention furthermore relates to a roller. The invention furthermore relates to a calender or an embossing cassette.

### CROSS-REFERENCE TO RELATED APPLICATIONS

This application claims priority to International Patent Application No. PCT/EP2023/072912, filed Aug. 21, 2023, which is incorporated herein by reference in its entirety.

### FIELD

The invention relates to a heating device for heating a roller, and a roller. The invention furthermore relates to a calender or an embossing cassette.

### BACKGROUND

Calenders and/or rollers are often used to produce and/or coat web-shaped carriers, such as films or the like. Calenders and/or rollers are also used in the production of electrodes, for example for batteries or battery cells, e.g. lithium-ion batteries or lithium-ion accumulators or the like.

For example, the cathode and/or anode of a battery cell can be produced by means of various active material coatings on metal foils, for example, made of copper for anodes or aluminum for cathodes. With the aid of a calender, also called a rolling mill, suitable coatings, such as a suitable electrode material or active material, can be applied to the metal foil. Setting the correct temperature of the rollers is essential because the chemical binder or primer used as an adhesion promoter between the metal foil and the coating material, such as the electrode material or active material, is activated by thermal energy.

Embossing cassettes can be configured and/or used for embossing and/or perforating web-shaped material. An embossing cassette can also be called an embossing calender. The embossing cassette can have a roller for embossing and/or perforating. The embossing cassette can have a second roller, such as a counter roller and/or second embossing roller. The web-shaped material can be guided between rollers of the embossing cassette. The web-shaped material can be embossed and/or perforated as it is guided through the embossing cassette. The web-shaped material can, for example, be or comprise a film. For example, the web-shaped material can comprise and/or consist of plastic and/or metal.

Important process and product parameters can be sensitively controlled via heating of the roller. For example, activation of the primer can be set to make the active materials adhesive to one another and/or to the metal foil. By selecting the roller temperature, a precise setting of the total thickness of the electrode can be achieved and/or, for example, the ductility of the material can be adjusted. In addition, stresses induced in the roller by a temperature gradient due to frictionally heated bearings can be dissipated or reduced.

Heating rollers via an oil heater is known. Hot oil is guided through channels in the roller to heat the roller. Such oil heaters are disadvantageous in that, on the one hand, oil is used as the working medium and an external heater for heating the oil and also feed lines and discharge lines have to be used, and, on the other hand, a comparatively long lead time results. Oil heaters therefore require a relatively long time until the roller is heated to a predetermined temperature. In addition, corresponding oil heaters are comparatively expensive. Furthermore, the oil or thermal oil used for oil heaters is usually only stable up to approximately 250° C., so that the use of oil heaters at temperatures above 250° C. is not reasonable or is even not possible.

Alternatively, heating rollers inductively is known. No working medium is required, but rather the roller is heated inductively by an electromagnetic field. Corresponding inductive heaters have a short lead time and can heat a roller to a specified temperature comparatively quickly. However, a high level of equipment expenditure with complex cabling and control is necessary. Inductive heaters are also comparatively expensive.

Electric heaters are known as another alternative. A bore is provided in the roller into which a heating element is inserted. However, it has proven to be a disadvantage that the heat generated by the heating element cannot be transferred well to the roller due to the bore.

To install a corresponding heating element in the bore, the heating element is lubricated using a graphite paste to simplify installation, although this paste evaporates after a certain period of operation. The heat transfer then only takes place via an air gap between the heating element and the roller body of the roller, which is determined by the fit. This results in a significantly reduced heat transfer because, on the one hand, the circumference of the heating element and thus its surface in the radial direction is small, and, on the other hand, the roller and in particular the air, which is located in a corresponding air gap between the heating element and the roller body after the graphite paste has evaporated, have a very low thermal conductivity. For example, steel S355, which the roller body is often consists of or at least comprises, has a thermal conductivity of approximately 54 W/(m K), whereas air has a thermal conductivity of approximately 0.0262 W/(m K). The air gap therefore acts as a heat transfer resistance.

As a result, the power required to heat the roller surface to the target temperature often cannot be reached during operation. In some cases, the heating element can even become so hot due to the poor heat dissipation that it burns out or becomes damaged.

For this reason, electric heaters have not proven effective up to this point and oil heaters are the frequently used means of choice.

These disadvantages are overcome by a heating device according to the invention as claimed in claim 1, a roller according to the invention as claimed in claim 9, and a calender or embossing cassette according to the invention as claimed in claim 15. The respective dependent claims each relate to particularly advantageous embodiments.

It is in particular an object of the present invention to provide a heating device, a roller, and a calender according to the invention which enable rapid heating of a roller. A heating device according to the invention, and accordingly a roller or calender or embossing cassette according to the invention, is also easy to install and maintain, as well as cost-effective.

It is also possible, simply and easily, to retrofit existing calenders and/or rollers with some embodiments of heating devices according to the invention.

A first aspect of the invention relates to a heating device for heating a roller, wherein the heating device has a heating element which is configured to be inserted into a bore of the roller and to provide heating power and/or heat for heating the roller and/or a roller body of the roller, and wherein the heating device has a clamping element which is arranged on a surface of the heating element and which is configured to contact an inner surface of the bore when the heating device is inserted into the bore of the roller and to transfer heat from the heating element conductively to the roller and/or the roller body.

The clamping element can contact the surface of the heating element.

The heating element can be configured to provide the heating power and/or heat electrically. The heating element can be configured to convert electrical energy into heat. The heating element can have or be a heating cartridge, or can be designated as such. The heating element can be or have a heating rod.

The clamping element can be annular. The clamping element can be or comprise a cone clamping element.

The clamping element and/or the cone clamping element can comprise a first clamping ring having a first inclined surface and a second clamping ring having a second inclined surface. The first surface and the second surface can contact and/or support one another. The first surface and the second surface can slide relative to one another and/or on one another. It can be provided that the first inclined surface is inclined relative to a straight surface of the first clamping ring. It can be provided that the second inclined surface is inclined relative to a straight surface of the second clamping ring. The respective angles of inclination can be selected such that when the first clamping ring and the second clamping ring contact one another with their inclined surfaces or lie one on top of another, the corresponding straight surfaces can be aligned substantially parallel to one another. An angle of inclination of the first inclined surface and/or the second inclined surface can be selected such that self-locking can occur, for example if the heating device can be accommodated in one or the bore. Alternatively, one or the angle of inclination of the first inclined surface and/or the second inclined surface can be selected such that self-locking cannot occur, for example if the heating device can be accommodated in one or the bore.

The clamping element can have a variable and/or adjustable thickness. The thickness of the clamping element can be variable and/or adjustable. If the first clamping ring has a first inclined surface and the second clamping ring has a second inclined surface, a thickness of the clamping element can be adjusted and/or varied by sliding and/or moving the first clamping ring and the second clamping ring relative to one another.

The clamping element can comprise one, several, or all of brass, bronze, aluminum, copper, and/or steel, and/or alloys comprising at least one of these. The clamping element can consist of one or more of brass, bronze, aluminum, copper, and/or steel. The clamping element can have a thermal conductivity of 120 W/(m K). The clamping element can have a thermal conductivity of greater than 120 W/(m K). The first clamping ring and/or the second clamping ring can comprise and/or consist of brass, bronze, and/or steel.

The heating element can be cylindrical. The heating element can be rod-shaped. The clamping element can be arranged on a lateral surface of the heating element.

The heating element can have a diameter between 5 mm and 40 mm. It can be provided that the heating element can have a diameter of 28 mm. In some embodiments, the heating element can have a diameter between 27 mm and 29 mm.

The clamping element can have a thickness of 2 mm to 8 mm. It can be provided that the clamping element can have a thickness of 4 mm. In some embodiments, the clamping element can have a thickness of 3.5 mm to 4.5 mm.

A further aspect of the invention relates to a roller having a roller body with one or more bores, wherein the roller has a heating device according to the invention which is inserted into the bore, wherein the clamping element contacts an inner surface of the bore, so that heat provided by the heating element is conductively transferable to the roller body and/or the roller by the clamping element.

In some embodiments, the roller can have exactly one bore. In some embodiments, the roller can have more than one bore. If the roller has more than one bore, a corresponding heating element can be inserted in at least one, multiple, or all of the bores. If the roller has more than one bore, in some embodiments at least two, multiple, or all of the bores can be arranged at an angle to one another, for example at an angle of 60°. At least one of the bores can be inclined, for example inclined in relation to an axis of symmetry and/or longitudinal axis of the roller.

The bore can be arranged on or in an axis of symmetry of the roller. The bore can extend in a longitudinal direction of the roller.

The heating device can be axially mounted in the bore between an adapter and a spring.

The spring preload travel can be adjustable. The preload travel of the spring can be adjustable so that an axial preload on the heating device can be settable. The preload travel of the spring can be adjustable via a screw connection.

The bore can have a diameter between 5 mm and 40 mm. In some embodiments, the bore can have a diameter of 32 mm. In some embodiments, the bore can have a diameter between 30.5 mm and 33.5 mm. If the roller has more than one bore, it can be provided that at least two, multiple, or all of the bores have the same diameter. Alternatively or additionally, at least two, multiple, or all of the bores can have different diameters. In some embodiments, bores of different diameters can enable and/or facilitate the accommodation of different heating elements and/or heating devices. In some embodiments, the accommodation of a heating device and/or heating device can be made possible in a flexible manner by bores of different diameters.

The heating device, or at least the heating element, can be detachably fastened to the roller and/or in the bore. The heating device, or at least the heating element, can be fastened to the roller and/or in the bore via a screw connection. The heating device, or at least the heating element, can be detachably fastened to or with the roller body and/or a pin of the roller. The heating device, or at least the heating element, can be fastened to or with the roller body and/or a pin of the roller via a screw connection.

Yet another aspect of the invention relates to a calender which has at least one roller according to the invention. Alternatively or additionally, the invention relates to an embossing cassette which has at least one roller according to the invention.

The calender can have a pair of rollers, which can comprise two rollers according to the invention, wherein the rollers of the pair of rollers can be heated using corresponding heating devices. The embossing cassette can have a pair of rollers, which can comprise two rollers according to the invention, wherein the rollers of the pair of rollers can be heated using corresponding heating devices.

### BRIEF DESCRIPTION OF THE DRAWINGS

The invention is further explained with reference to the following figures. In the figures:

FIG. 1: shows a roller known from the prior art;

FIG. 2: shows a comparison of a section of a roller known from the prior art and a section of a roller according to the invention;

FIG. 3 shows a perspective view of an embodiment of the roller according to the invention;

FIG. 4: shows a comparison of a temporal temperature profile of a heated roller known from the prior art and a heated roller according to the invention.

### DETAILED DESCRIPTION

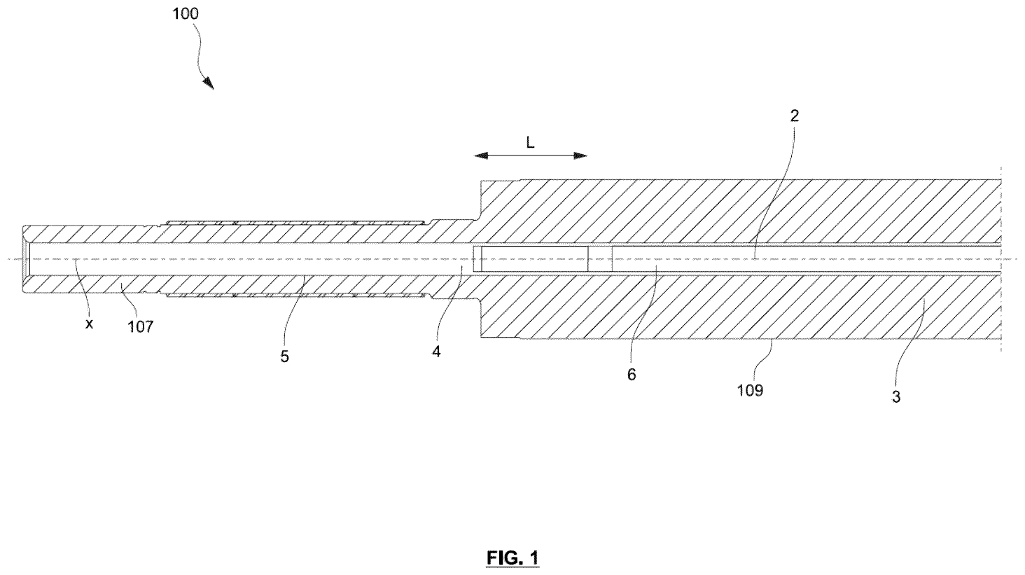

FIG. 1 shows a roller 100 known from the prior art. The roller 100 has a roller body 3. The roller 100 can be or comprise a calender roller. The roller 100 can be or comprise an embossing roller. The roller 100 can be or comprise an engraved roller. The roller body 3 can have a roller surface 109 which can be used for calendering and/or embossing. In some embodiments, the roller 100 can be configured and/or used for engraving, printing, and/or perforating. The roller 100 can be configured to be used and/or employed in or with a calender and/or an embossing cassette.

The roller 100 and/or the roller body 3 can be cylindrical and/or rod-shaped. The roller surface 109 can correspond to a lateral surface of the roller 100. The roller 100 can have a pin 107. The pin 107 can be used for mounting. The roller 100 can, for example, be clamped with the pin 107. It can be provided that a pin 107 can be arranged in each case at opposite ends of the roller body 3. The roller 100 can have an axis of rotation X around which it can be rotatable, for example it can be rotatably mounted. The roller 100 has a bore 4. In some embodiments, the bore 4 can extend completely through the roller 100. It can be provided that the bore 4 extends along a longitudinal direction L of the roller 100. In some embodiments, the bore 4 can extend along an axis of symmetry of the roller 100, for example a longitudinal axis and/or the axis of rotation X. It can be provided that the bore 4 and/or an extension axis of the bore 4 can substantially coincide with one or the axis of symmetry, longitudinal axis, and/or axis of rotation X of the roller 100.

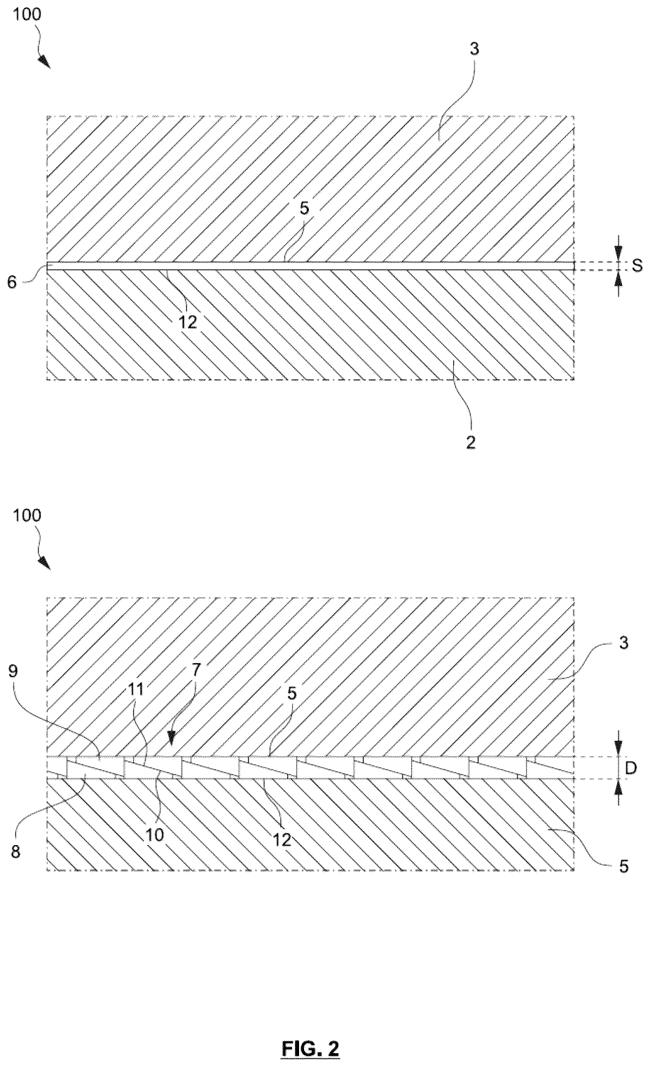

In the roller 100 known from the prior art, a heating element 2 is provided in the bore 4. The heating element 2 can, for example, be and/or have a heating rod. There is an air gap 6 between the heating element 2 and an inner surface 5 of the bore 4. FIG. 2 (upper figure) shows a corresponding section of a roller 100 known from the prior art. In the rollers 100 known from the prior art, the heating element 2 therefore cannot contact the roller body 3 and/or the bore 4, but is separated from it by the air gap 6. The air gap 6 can be located between a lateral surface 12 of the heating element 2 and an inner surface 5 of the bore 4, and/or can be formed thereby. The air gap 6 can have a thickness S, which in the embodiments of the roller 100 known from the prior art can be several millimeters. Thus, the air gap 6 acts as an insulation between the heating element 2 and the roller body 3. Thus, a transfer of the heat generated by the heating element 2 to the roller body 3 is reduced and/or restricted by the air gap 6. This results in a slow heating of the roller 100 and/or the roller body 3, as well as a reduced maximum temperature. In addition, in some cases the heating element 2 may be damaged by heat because the heat it generates cannot be or is not dissipated properly.

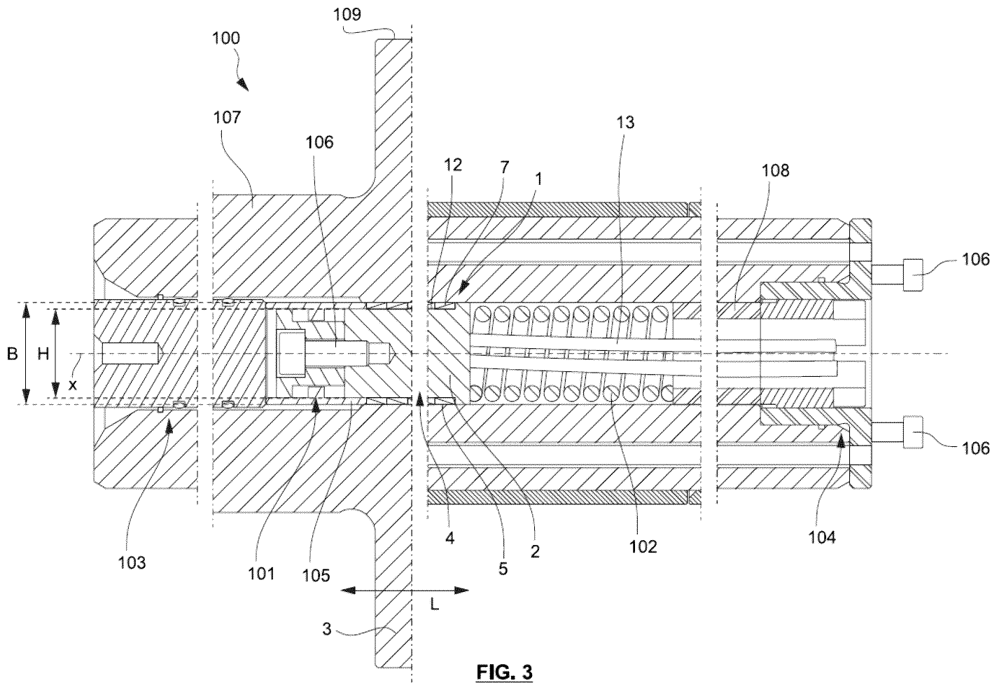

A section of an embodiment of a roller 100 according to the invention and a roller 100 according to the invention, each having heating devices 1 according to the invention, is shown in FIG. 2 (bottom) and FIG. 3.

The heating device 1 according to the invention has a heating element 2 and a clamping element 7. The heating element 2 can correspond to the heating element 2 known from the prior art. The heating element 2 can be inserted into one or the bore 4 of the roller 100. The heating element 2 can provide heating power and/or heat for heating the roller 100 and/or the roller body 3. For example, the heating element 2 can provide the heating power and/or heat electrically, and/or generate and/or convert it from electrical energy. The heating element 2 can be or comprise a heating rod, for example.

The clamping element 7 is arranged on a surface of the heating element 2. The heating element 2 can be cylindrical and/or rod-shaped. The surface can, for example, be and/or correspond to a lateral surface 12 of the heating element 2. When the heating device 1 is inserted into one or the bore 4 of the roller 100, one or the inner surface 5 of the bore 4 can be contacted by the clamping element 7. This allows heat to be conductively transferred from the heating element 2 to the roller 100 and/or the roller body 3. The clamping element 7 can cause and/or provide heat conduction between the heating element 2 and the roller body 3.

In particular, the clamping element 7 can fill one or the air gap 6, in some embodiments essentially completely fill it. The clamping element 7 can be annular and/or can have one or more clamping rings. It can be provided that the clamping element 7 has a first clamping ring 8 and a second clamping ring 9, and/or consists of one or more first clamping rings 8 and second clamping rings 9. The clamping element 7 can be or have a cone clamping element. The cone clamping element can have the first clamping ring 8 and the second clamping ring 9. The clamping element 7 can be conical. The first clamping ring 8 and/or the second clamping ring 9 can be conical.

If the clamping element 7 is annular, an increased effective surface and/or better heat transfer can result due to the larger surface on the outside of the annular clamping element 7 (which can contact the inner surface 5 of the bore 4 and/or which can substantially correspond to a straight surface of the second clamping ring 9 or the second clamping rings 9) compared to the smaller surface of the heating element 2 (which can, for example, contact the inner surface of the annular clamping element 7 and/or which can substantially correspond to a straight surface of the first clamping ring 8 or the first clamping rings 8).

The first clamping ring 8 can have an inclined first surface 10. The first clamping ring 8 can have a substantially straight surface, which can be arranged opposite to the inclined first surface 10. The first surface 10 can be oblique and/or inclined relative to the straight surface. The first clamping ring 8 can be wedge-shaped and/or have a wedge shape. The second clamping ring 9 can have an inclined second surface 11. The second clamping ring 9 can have a substantially straight surface, which can be arranged opposite to the inclined second surface 11. The first surface 11 can be oblique and/or inclined relative to the straight surface. The second clamping ring 9 can be wedge-shaped and/or have a wedge shape.

It can be provided that the straight surface of the first clamping ring 8 can contact the heating element 2 and/or its surface and/or lateral surface 12, for example can contact it over a large area. The straight surface of the first clamping ring 8 can rest on the heating element 2 and/or its surface and/or lateral surface 12 and/or can be supported thereby. The straight surface of the second clamping ring 9 can contact the roller body 3 and/or the bore 4, and/or its inner surface 5, for example contact it over a large area. The straight surface of the second clamping ring 9 can rest on the roller body 3 and/or the bore 4, and/or its inner surface 5, and/or can be supported thereby.

A respective angle of inclination of the first inclined surface 10 and the second inclined surface 11 can be selected such that when the first clamping ring 8 and the second clamping ring 9 contact one another and/or lie one on top of another via the respective inclined surfaces 10, 11, the respective straight surfaces of the clamping rings 8, 9 are aligned parallel to one another and/or extend parallel to one another. In some embodiments, one or their respective angles of inclination may be selected such that self-locking can occur. In some embodiments, however, one or the angles of inclination can be selected in such a way that self-locking cannot occur. It can be provided that the angle(s) of inclination is/are selected such that the heating device 1, the heating element 2, and/or the clamping element 7 can be easily removed from the bore 4.

The clamping element 7 can have a plurality or large number of first clamping rings 8. The clamping element 7 can have a plurality or large number of first clamping rings 9. A first clamping ring 8 and a second clamping ring 9 can each lie one on top of another and/or contact one another essentially in the radial direction. Adjacent first clamping rings 8 and/or second clamping rings 9 can contact and/or secure one another laterally and/or axially. In some embodiments, a first clamping ring 8 can contact and/or secure an adjacent second clamping ring 9 laterally and/or axially. In some embodiments, a second clamping ring 9 can contact and/or secure an adjacent first clamping ring 8 laterally and/or axially.

The first clamping ring 8 and the second clamping ring 9 can be arranged such that the inclined first surface 10 and the inclined second surface 11 contact one another. The first clamping ring 8 and/or the second clamping ring 9 can slide and/or be moved relative to one another. Due to the inclined surfaces of the first clamping ring 8 and the second clamping ring 9, a thickness D of the clamping element 7 can be adjusted and/or varied. In this way, good contact between the heating element 2 and the roller body 3 can be ensured by the clamping element 7. In addition, the adjustable and/or variable thickness D of the clamping element 7 allows air gaps 6 of different thicknesses S to be well bridged and/or filled. It can be provided that the clamping element 7, and/or the first clamping ring 8 and second clamping ring 9 (or multiple first clamping rings 8 and correspondingly multiple second clamping rings 9) are fixed and/or secured in the bore 4 so as to be displaced relative to one another in such a way that a thickness D of the clamping element 7 is achieved and/or the clamping element 7 has a predetermined thickness D.

The clamping element 7 can consist of a material or comprise a material that can have good thermal conductivity. The first clamping ring 8 and/or the second clamping ring 9 can consist of a material or comprise a material that can have good thermal conductivity. In some embodiments, the material can be or comprise steel, bronze, and/or brass. The material can consist of a composition of multiple materials and/or can comprise multiple materials. In some embodiments, the material can be or comprise an alloy. In some embodiments, the clamping element 7 can have a thermal conductivity of 120 W/(m K). In some embodiments, the clamping element 7 can have a thermal conductivity of greater than 120 W/(m K). In some embodiments, it can be provided that the first clamping ring 8 and the second clamping ring 9 consist of different materials and/or comprise different materials. Alternatively, it can be provided that the first clamping ring 8 and the second clamping ring 9 consist of and/or comprise the same material.

FIG. 3 shows various details and/or sections of an embodiment of a roller 100 according to the invention. The roller 100 has a roller body 3. The roller 100 has a bore 4. A heating device 1 according to the invention is inserted into the bore 4. The roller 100 and/or the heating device 1 can have one, multiple, or all of the features and/or advantages of the roller 100 and/or heating device 1 described above.

A clearance fit of the heating element 2 in the bore 4 can be provided. The clearance fit can be bridged and/or filled by the clamping element 7. The heating element 2 can have a diameter H between 5 mm and 40 mm. The heating element 2 can have a diameter H between 27 mm and 29 mm. It can also be provided that the heating element 2 has a diameter H of 28 mm. The bore 4 can have a diameter B between 5 mm and 40 mm. The bore 4 can have a diameter B between 30.5 mm and 33.5 mm. It can be provided that the bore 4 can have a diameter B of 32 mm. The clamping element 7 can have a thickness D of 2 mm to 8 mm. In some embodiments, the clamping element 7 can have a thickness D of 3.5 mm to 4.5 mm. It can be provided that the clamping element 7 can have a thickness D of 4 mm.

The roller 100 and/or the roller body 3 can be cylindrical and/or rod-shaped. The roller 100 and/or the roller body 3 can have a roller surface 109 which can serve and/or be used for calendering and/or embossing. The roller surface 109 can be or comprise an outer lateral surface of the roller body 3. The roller 100 can have one or more pins 107. The pin 107 can be arranged distally. The pin 107 can be arranged at one end of the roller body 3. It can be provided that a pin 107 can be arranged in each case at opposite ends of the roller body 3. The pin 107 can be used to mount the roller 100, e.g. in a rolling bearing or pivot bearing. The roller 100 can be clamped via the pin 107.

The bore 4 can extend at least partially or completely through the roller 100 and/or the roller body 3. The bore 4 can be arranged along a longitudinal direction L of the roller 100 and/or the roller body 3. The bore 4 can be arranged and/or extend substantially parallel to the longitudinal direction L and/or an extension direction of the calender roll 100 and/or the roll body 3. It can be provided that the bore 4 can be arranged centrally. The bore 4 can essentially coincide with one or the axis of rotation X of the roller 100.

The heating device 1 and/or the heating element 2 is configured to heat the roller 100 and/or the roller body 3. The roller 100 and/or the roller body 3 can be heated to a temperature, for example a predetermined temperature, by the heating device 1 and/or the heating element 2. In some embodiments, it can be provided that the temperature can be controlled and/or regulated, and/or can be predetermined.

The heating element 2 can be cylindrical and/or rod-shaped. The heating element 2 can have a surface, for example on a lateral surface 5. The clamping element 7 contacts the heating element 2, for example its surface and/or lateral surface 5. The clamping element 7 contacts an inner surface 5 of the bore 4. The clamping element 7 can thus transfer heat from the heating element 2 to the inner surface 5 of the bore 4, and/or the roller body 3 and/or the roller 100, in particular by heat conduction. The clamping element 7 can, for example, have one or more of the first clamping rings 8 and second clamping rings 9 described above.

FIG. 3 shows an example of accommodation and/or fastening of the heating device 1 in the bore 4. The heating device 1 can be secured in the axial direction, in particular in the longitudinal direction L. The roller 100 can have an adapter 101 and a screw connection 104, which can axially secure the heating device 1 and/or the heating element 2. The heating device 1 can be arranged in the bore 4 in the axial direction between the adapter 101 and the screw connection 104.

The adapter 101 can contact the heating device 1 and/or the heating element 2 in the axial direction and/or counteract a displacement and/or movement of the heating device 1 and/or the heating element 2 in at least one direction parallel to the axial direction. In some embodiments, the adapter 101 can have a sleeve 105 that can contact the heating device 1 and/or the heating element 2, for example, can contact it laterally. The adapter 101 and/or the sleeve 105 can exert a force that can prevent movement of the heating device 1 and/or the heating element 2 in one direction. For example, in the arrangement shown in FIG. 3, the adapter 101 and/or the sleeve 105 can counteract and/or prevent movement of the heating device 1 and/or the heating element 2 in the bore 4 “to the left” in FIG. 3.

In some embodiments, the adapter 101 and/or the sleeve 105 can contact the clamping element 7, for example contact it laterally, and/or block and/or counteract an axial movement of the clamping element 7 in at least one direction. In some embodiments, the heating element 2 can have a stop that the clamping element 7 can contact. In some embodiments, the clamping element 7 can be guided and/or pressed against the stop. It can be provided that the adapter 101 and/or the sleeve 105 can push and/or press the clamping element 7 against the stop, and/or the adapter 101 and/or the sleeve 105, together with the stop, can axially secure or lock the clamping element 7.

The adapter 101 can be fastened, for example, via a detachable connection, for example having one or more screws 106. It can be provided that the adapter 101 can be fastened or mounted to or with the heating device 1 and/or the heating element 2. In some embodiments, the adapter 101 can be screwed and/or fastened to the heating device 1 and/or the heating element 2 via a or the detachable connection, for example using one or more screws 106. In some embodiments, a second adapter 103 can be provided that can axially secure the adapter 101 and/or exert a force on the adapter 101 that can counteract, block, and/or prevent movement and/or displacement of the adapter 101 in a direction, for example parallel to the longitudinal direction L and/or an axial direction. It can be provided that the second adapter 103 can be screwed to the pin 107 and/or fastened thereon, for example.

The screw connection 104 can counteract a displacement and/or movement of the heating device 1 and/or the heating element 2 in at least one direction parallel to the axial direction. The direction can be opposite to the direction in which movement can be prevented and/or blocked by the adapter 101. In some exemplary embodiments, the screw connection 104 can contact the heating device 1 and/or the heating element 2 in the axial direction. In some embodiments, a spring 102 can be provided, which can be arranged between the heating device 1 and the screw connection 104. In some embodiments, the screw connection 104 can include a pressure piece 108 that can act on the spring 102. The spring 102 can contact the heating device 1 and/or the heating element 2, for example contact it laterally. For example, the screw connection 104 and/or the spring in the exemplary embodiment in FIG. 3 can counteract and/or lock the movement and/or displacement of the heater 1 and/or the heating element 2 in the bore 4 “to the right”.

The screw connection 104 can be detachably fastened, for example via one or more screws 106. In some embodiments, the screw connection 104 can fastened to or with the roller 100 and/or a pin 107.

A preload of the spring 102 and/or a force, in particular a spring force, exerted by the spring 102 on the heating device 1 and/or the heating element 2 can be adjusted by the screw connection 104. A spring travel and/or a restoring force of the spring 102 can be adjusted by the screw connection 104. The spring 102 can act as a compression spring. The spring 102 can exert a spring pressure and/or a spring force on the heating device 1 and/or the heating element 2. The spring 102 can be a spiral spring. In some embodiments, alternatively or additionally, the pressure piece 108 can be dimensioned in such a way, in particular have such a length, that a predetermined spring force and/or a predetermined spring travel of the spring 102 can be or will be set.

The heating device 1 and/or the heating element 2 can be detachably accommodated in the bore 4. The heating device 1 and/or the heating element 2 can be detachably fastened to or with the roller 100 and/or the roller body 3. The clamping element 7 can be detachably accommodated in the bore 4. The clamping element can be detachably fastened to or with the roller 100 and/or the roller body 3. This means that the heating device 1, the heating element 2, and/or the clamping element can be mounted or removed easily and simply. For example, a defective heating element 2 can be replaced quickly and easily. It is also possible to retrofit already installed rollers or calenders with a heating device 1 according to the invention easily and simply.

In some embodiments, reference numeral 13 in FIG. 3 can denote, for example, a cable, an electrical line, a hose, and/or a cable duct. In some embodiments, energy, for example electrical energy, which can be converted into heat by the heating element 2, can be provided and/or supplied to the heating device 1 and/or the heating element 2 by a cable and/or an electrical line.

Even though the heating element 2 can be or comprise an electrical heating element, or at least can be designed to generate and/or convert heat from electrical energy, the invention is not necessarily limited to such a heating element. Other heating elements 2 are also conceivable, which obtain, convert, or at least provide heat in a different way.

The roller 100 can be part of a calendar (not shown in the figures). A calender can have one or more rollers 100 according to the invention. For example, a calender can have at least one pair of rollers, which can be formed by rollers 100 according to the invention.

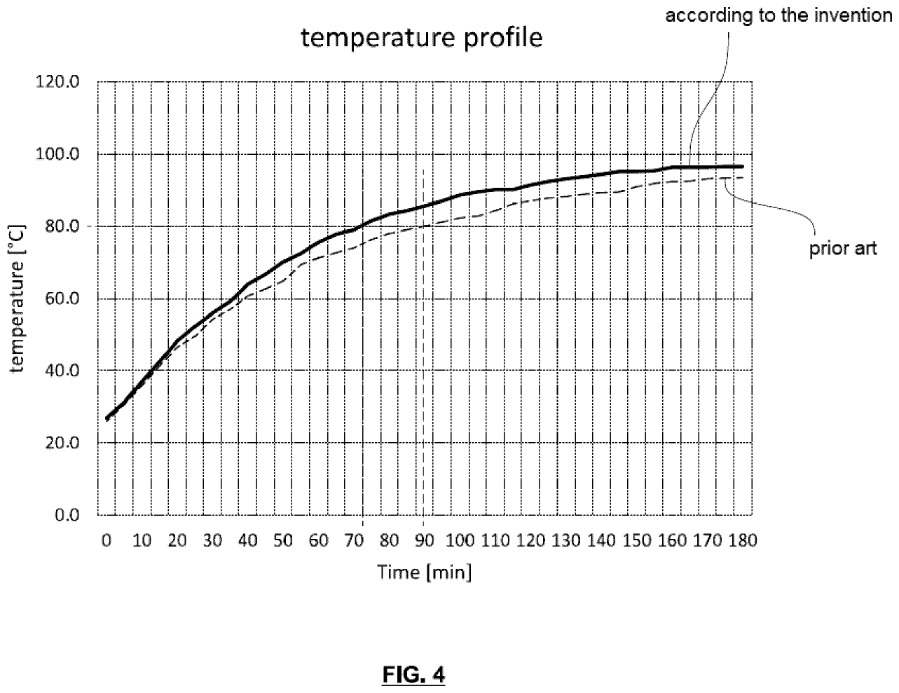

FIG. 4 shows exemplary temperature profiles of a roller 100 according to the invention compared with a roller 100 known from the prior art as a function of time. The roller 100 according to the invention can correspond to a roller 100 shown and described in FIG. 2 (below) and FIG. 3. The roller 100 known from the prior art can correspond to a roller 100 shown and described in FIG. 1 and FIG. 2 (above).

The two compared rollers 100 differ only in the heating device 1 and the clamping element 7. In other words, the respective roller bodies 3 and bores 4 have the same dimensions. Both rollers 100, i.e. both the roller 100 according to the invention and the roller 100 known from the prior art, were cooled on their outer surface, or the surface of the respective roller body 3, in order to depict a corresponding cooling of the roller surfaces during operation. The respective temperatures were measured at the same locations centrally (in radial direction) in the roller body 3 parallel to the respective axes of rotation X. The same amount of energy was supplied to the respective heating elements 2.

As can be seen from FIG. 4, a heating device 1 according to the invention enables a roller 100 according to the invention to be heated to a temperature of 80° C. within a time of approximately 72.5 minutes. In contrast, heating up a roller 100 known from the prior art requires a time of approximately 90 minutes. The present invention thus enables a significant reduction of a time required for heating to a predetermined temperature and thus provides a heating time shortened by a time difference Δt. Since the respective temperature curves are concave, the time difference Δt is higher the higher the desired temperature or set target temperature is.

A heat transfer coefficient α of the heat transfer from heating element 2 to roller body 3 can be greater by a factor of 1.2 or more, for example by a factor of 1.24, than is known from the prior art due to the present invention.

The features of the invention disclosed in the above description, in the figures, and in the claims can be essential for the implementation of the invention both individually and in any combination.

### LIST OF REFERENCE SIGNS

1 heating device
2 heating element
3 roller body
4 bore
5 inner surface
6 air gap
7 clamping element
8 first clamping ring
9 second clamping ring
10 first surface
11 second surface
12 lateral surface
13 line/cable/cable feed/hose
100 roller
101 adapter
102 spring
103 second adapter
104 screw connection
105 sleeve
106 screw
107 pin
108 pressure piece
X axis of rotation
L longitudinal direction
H diameter
D thickness
B diameter
S thickness
Δt time difference

1. A heating device for heating a roller, wherein the heating device has a heating element which is configured to be inserted into a bore of the roller and to provide, to provide electrically, heating power and/or heat for heating the roller and/or a roller body of the roller, and wherein the heating device has a clamping element which is arranged on a surface of the heating element and which is configured to contact an inner surface of the bore when the heating device is inserted into the bore of the roller and to transfer heat from the heating element conductively to the roller and/or the roller body.

2. The heating device according to claim 1, wherein the clamping element is annular and/or is or has a conical clamping element.

3. The heating device according to claim 1, wherein the clamping element has a first clamping ring having a first inclined surface and a second clamping ring having a second inclined surface, wherein the first surface and the second surface contact and/or support one another.

4. The heating device according to claim 1, wherein the clamping element has a variable and/or adjustable thickness (D).

5. The heating device according to claim 1, wherein the clamping element comprises one, multiple, or all of brass, bronze, aluminum, copper, and/or steel, or consists of one, multiple, or all of brass, bronze, aluminum, copper, and/or steel.

6. The heating device according to claim 1, wherein the heating element is cylindrical and/or rod-shaped, wherein the clamping element is arranged on a lateral surface of the heating element.

7. The heating device according to claim 1, wherein the heating element has a diameter (H) between 5 mm and 40 mm.

8. The heating device according to claim 1, wherein the clamping element has a thickness (D) of 2 mm to 8 mm.

9. A roller having a roller body having one or more bores, wherein the roller has a heating device according to claim 1, which is inserted into the bore, wherein the clamping element contacts an inner surface of the bore so that heat provided by the heating element is conductively transferable to the roller and/or the roller body through the clamping element.

10. The roller according to claim 9, wherein the bore is arranged on or in an axis of symmetry of the roller, wherein the bore extends in a longitudinal direction of the roller.

11. The roller according to claim 9, wherein the heating device is axially mounted in the bore between an adapter and a spring.

12. The roller according to claim 11, wherein a preload path of the spring is adjustable via a screw connection, so that an axial preload on the heating device is adjustable.

13. The roller according to claim 9, wherein the bore has a diameter between 5 mm and 40 mm.

14. The roller according to claim 9, wherein the heating device, or at least the heating element, is detachably fastened to the roller and/or in the bore, via a screw connection.

15. A calender or embossing cassette, which has at least one roller according to claim 9, wherein the calender or the embossing cassette has a pair of rollers which comprises two rollers, which are heated using corresponding heating devices.
